(19) United States
(12) Patent Application Publication
(10) Pub. No.: US 2005/0279817 A1
(43) Pub. Date: Dec. 22, 2005

(54) Mailbox cover and method of attaching the mailbox cover to a mailbox

(76) Inventor: L.M. Anderson Susan, Greenwich, CT (US)

Correspondence Address: Alfred E. Miller, 406 West Putnam Avenue, Greenwich, CT, 06830, US

(21) Appl. No.: 10/871,835

(22) Filed: Jun. 18, 2004

(51) Int. Cl. B65G 11/04

(52) U.S. Cl. 232/45

(57) ABSTRACT

A decorative cover for a mailbox includes a weather-resistant sheet having an exterior surface, the sheet defining a cutout portion positioned thereon to allow a flag forming part of the mailbox to pass there through when the sheet is positioned on the mailbox, and means for removably attaching the sheet onto an exterior surface of the mailbox. A kit for removably attaching a cover to a mailbox includes a sheet having an exterior surface and defining a cutout portion positioned thereon to allow a flag forming part of the mailbox to pass there through when the sheet is positioned on the mailbox, means for removably attaching the sheet onto an exterior surface of the mailbox, and means for providing a user-defined design on the exterior surface of the sheet. A method of installing a mailbox cover on a mailbox includes attaching one of a hook portion and a loop portion of a hook-and-loop fastener material to an outer surface of the mailbox and attaching the other of the loop portion and the hook portion to an inner surface of a sheet. The corresponding hook portions and loop portions are then engaged to secure the sheet to the outer surface of the mailbox. A method of decorating a mailbox includes applying a user-defined design to a sheet attached to an outer surface of the mailbox. A method of extending the perimeter of a decorative mailbox cover includes cutting a shaped edge or removing areas of the cover.

### FIELD OF THE INVENTION

The present invention generally relates to covers that fit over mailboxes and is more specifically directed to removable form-fitting covers mounted to mailboxes.

### BACKGROUND OF THE INVENTION

Mailboxes placed adjacent to a street are oftentimes painted so as to depict pictorial or graphical representations. Such representations, because they are painted onto the outer surfaces of the mailboxes, tend to weather as a result of various environmental conditions. In particular, the paint may fade, chip, peel, and/or crack in response to variations in temperature and exposure to sun, wind, rain, snow, and road dirt. Furthermore, although most mailboxes are fabricated from aluminum sheets, the use of non-aluminum screws, nails, or other fasteners to mount the mailbox oftentimes results in galvanic reactions that cause unsightly corrosion to appear at the points at which the fasteners engage the mailbox. On mailboxes having white- or light-colored surfaces, such corrosion detracts from the pictorial or graphical representation.

The painting of representations on mailboxes, furthermore, is substantially permanent. Making alterations (or even touch ups) to the design typically involves removing; the mailbox from its mounting post, repainting, and reassembling the mailbox on its mounting post. Because of the permanency of the representation, changing of the design to reflect the celebration of holidays or special occasions (e.g., birthdays, graduations, etc.) is difficult if not impossible without removing and reinstalling the entire mailbox.

In addition, mailboxes having designs thereon can be costly, and, as mailboxes are often vandalized, the purchase of such a mailbox may be foregone.

Based on the foregoing, it is a general object of the present invention to provide a decorative mailbox cover that overcomes the problems associated with the prior art or improves upon the prior art.

### SUMMARY OF THE INVENTION

The present invention is directed in one aspect to a decorative cover for a mailbox that includes a weather-resistant sheet having an exterior surface, the sheet defining a cutout portion positioned thereon to allow a flag forming part of the mailbox to pass there through when the sheet is positioned on the mailbox, and means for attaching the sheet onto an exterior surface of the mailbox which will allow it to be easily removed and replaced. One type of device that can be used to attach the sheet to the mailbox is hook-and-loop fastener material. In a preferred embodiment, the sheet is removably disposed on the mailbox; using the hook-and-loop fastener material such that the sheet can be reattached or such that a different sheet can be attached.

In another aspect, the present invention is directed to a kit for removably attaching a cover to a mailbox. The kit includes a sheet having an exterior surface and defining a cutout portion positioned thereon to allow a flag forming part of the mailbox to pass there through when the sheet is positioned on the mailbox, means for removably attaching the sheet onto an exterior surface of the mailbox, and means for providing a user defined design on the exterior surface of the sheet. The means for removably attaching the sheet to the mailbox may be hook-and-loop fastener material. The means for providing a user defined design may include adhesive elements, cutout elements, light reflective devices, light emitting devices, pockets that are attachable to the sheet, and marking instruments such as pens, pencils, markers, and the like.

In another aspect, a method of installing a mailbox cover on a mailbox includes attaching one of a hook portion and a loop portion of a hook-and-loop fastener material to an outer surface of the mailbox and attaching the other of the loop portion and the hook portion to an inner surface of a sheet. The corresponding hook portions and loop portions are then engaged to secure the sheet to the outer surface of the mailbox.

In still another aspect, a method of decorating a mailbox includes applying a user-defined design to a sheet attached to an outer surface of the mailbox.

One advantage of the present invention is that the mailbox cover can be easily removed and replaced. In particular, because of the use of hook-and-loop material as the attachment device, an old mailbox cover can be easily removed and a new mailbox cover can be reattached without using tools. Furthermore, if the mailbox becomes damaged or otherwise unusable, the mailbox cover can be removed and reattached to a new box.

Another advantage is that the mailbox cover may be used to disguise minor dents and discolorations on the mailbox due to age and weather corrosion.

Another advantage of the present invention is that the mailbox cover can be suited to a particular holiday, celebration, or occasion. Once the holiday, celebration, or occasion is over, the decorative mailbox cover can be removed and either discarded or saved for the next holiday, celebration, or occasion.

Still another advantage is that the decorative mailbox cover can be customized to provide a personal expression of the mailbox owner. For example, adhesive elements of various shapes and/or configurations can be disposed on the cover to impart a unique design to the mailbox. Such adhesive elements may include photographs, representations of vocations or hobbies, or the like.

### BRIEF DESCRIPTION OF THE DRAWINGS

FIG. 1 is an exploded perspective view of a decorative cover disposed on a mailbox.

FIG. 2 is a perspective view of a decorative cover peeled away from a corner of a mailbox to show the positioning of hook-and-loop material used to secure the decorative cover to the mailbox.

FIG. 3 is a perspective view of a decorative cover peeled away from a corner of a mailbox to show an alternate positioning of hook-and-loop material used to secure the decorative cover to the mailbox.

FIG. 4 is a perspective view of a mailbox having a decorative cover on which decorative stickers are adhered, a pocket is attached, and designs are made using a marking instrument and a paintbrush.

FIG. 5 is a perspective view of a pocket having a backing and a transparent window.

FIG. 6 is a perspective view of a mailbox having a decorative cover in which holes are disposed and ribbon is threaded.

FIG. 7 is a perspective view of a mailbox having a decorative cover on which decorative appendages are attached.

FIG. 8 is a perspective view of a mailbox having a decorative cover on which a shaped edge is disposed.

### DESCRIPTION OF THE PREFERRED EMBODIMENTS OF THE INVENTION

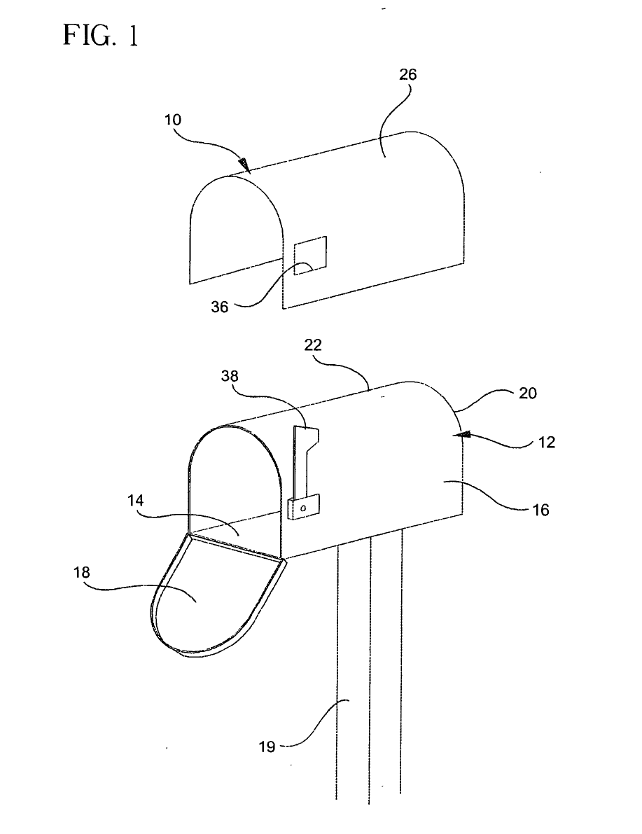

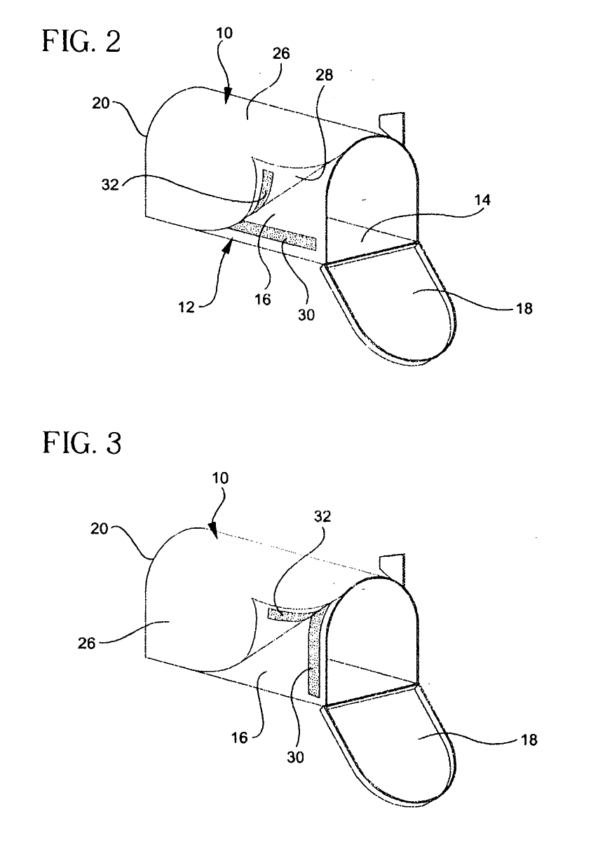

Referring to FIGS. 1 and 2, a decorative cover for use with a mailbox is shown generally at 10. The decorative cover 10 is configured to be installed on a mailbox that conforms to United States Postal Service standards. One exemplary embodiment: of a mailbox that conforms to United States Postal Service standards is shown generally at 12 and includes an elongated base 14 having two opposing longer sides and two opposing shorter sides, a shell 16 that extends between the opposing longer sides of the base 14, a door 18 at one shorter side of the base 14 to provide access to the inside of the mailbox 12, and either another door or a wall 20 at the other shorter side of the base 14 connecting the base 14 and the shell 16. In such an embodiment, the edge portions of the shell 16 connected at the opposing longer sides of the base 14 are substantially parallel to each other and substantially perpendicularly disposed to the base 14. The shell 16 may form a rounded top portion 22 that: extends between the shorter opposing sides of the base 14, or it may be defined by a plurality of substantially planar members angularly arranged and attached to each other. A flag 38 or similar indicator may be located on an outer surface of the shell 16 and attached thereto so as to be positionable in at least two positions. The mailbox 12 may be disposed on a stake 19 mounted in the ground.

The decorative cover 10 preferably comprises a sheet 26 of material that fits on and substantially conforms to an outer surface of the shell 16 of the mailbox 12. If access; to the mailbox 12 is not desired through both ends, the sheet 26 may extend to the back of the mailbox 12 and be secured thereto. The sheet 26 has an inner surface that is disposed against the outer surface of the shell 16 and an exterior surface that is exposed to the environment. Ir. one alternate embodiment, the sheet 26 (as mounted on the mailbox 12) may extend away from the outer surface of the shell 16 to define a decorative embodiment that is displaced from the shell 16. In either case, the sheet 26 is removably attached to the mailbox 12 using a: suitable attachment means. Suitable attachment means include, but are not limited to, hook and-loop fastener material, double-sided tape, magnets, elastic members, mechanical fasteners (e.g., screws, nut/bolt assemblies), and the like. Preferably, such means are attachable at an inner surface 28 of the sheet 26 and the outer surface of the shell 16.

As is shown in FIG. 2, the suitable means of attaching the decorative cover 10 to the mailbox 12 is hook-and-loop fastener material. The hook-and-loop fastener material includes a hook portion 30 and a loop portion 32, one of the hook portion 30 and the loop portion 32 being attached to the inner surface 28 of the sheet 26 and the other of the loop portion 32 and the hook portion 30 being attached to the outer surface of the shell 16. Each hook portion 30 and its attendant loop portion 32 is preferably positioned proximate the outer edges of the sheet 26 to provide for the secure mounting of the sheet 26 to the shell 16. The hook-and-loop fastener material may be fastened along the edges of the sheet 26 and the shell 16 parallel to the edge at which the shell 16 attaches to the base 14, as is shown. Alternately, the hook-and-loop fastener material may be fastened such that the hook material 30 and the loop material 32 extend along the edges of the sheet 26 and over the shell 16 along the edges at which the door 18 and the wall 20 (or the other door) connect to the shell 16, as is shown in FIG. 3.

As seen FIG. 2, the hook portion 30, after being applied to the mailbox, can remain on the mailbox if the owner wishes to replace the decorative cover with another decorative cover. In that case, the loop portion 32 of the new cover engages the fixed hook 30 to hold the new cover on the mailbox. In either embodiment shown in FIGS. 2 or 3, the other suitable means of attachment (e.g., double-sided tape, magnets, elastic members, mechanical fasteners, and the like) may be utilized.

Referring back to FIG. 1, the sheet 26 includes a hole 36 disposed there through. The hole 36 is positioned and dimensioned so as to register with and receive the flag 38 when the decorative cover 10 is used with the mailbox 12, thereby enabling a mailbox user to position the flag 38 without interference from the decorative cover 10. The sheet 26 is preferably fabricated from a thermoplastic—or rubber material (e.g., a vinyl compound) capable of withstanding various environmental conditions. Other materials from which the sheet 26 may be fabricated includes, but are not limited to, paper, paper laminated with a plastic material, metal foils, and the like.

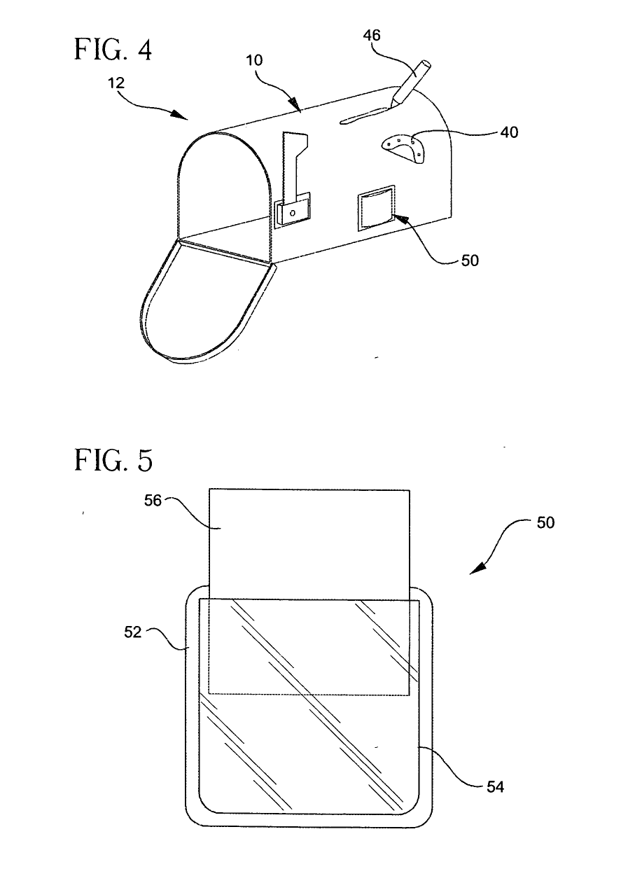

The sheet 26 may include a pre-printed design in the form of a pictorial—or graphical representation on its outer surface as the decorative aspect of the decorative cover 10. Alternately, the sheet 26 may be plain (e.g., white or colored) or partially designed to allow for a user-defined design. As used herein, the term “user-defined design” is intended to indicate a design provided by the mailbox owner in response to the owner's artistic inclinations. Such designs may be paintings, drawings, or the like, rendered with a marking instrument 46 (e.g., a pen, pencil, or marker), as is shown with reference to FIG. 4. Furthermore, the surface of the sheet 26 of the decorative cover 10 may be such that decorative items or functional items such as adhesive elements 40 (e.g., letters or symbols) as well as light reflective devices, light emitting devices, cutout elements, or similar devices can be attached directly thereto, as is also shown with reference to FIG. 4.

Referring now to FIGS. 4 and 5, a pocket that may be used to decorate the sheet 26 of the decorative cover 10 is shown generally at 50. The pocket 50 includes a backing member 52 and a transparent window 54 coupled to the backing member 52 such that a member 56 having a photograph, graphic, or the like printed thereon can be inserted and retained between the backing member 52 and the transparent window 54. Tire pocket 50 may be mounted on the mailbox or on the sheet 26 as part of the decorative cover 10 using adhesives means, magnets, or the like.

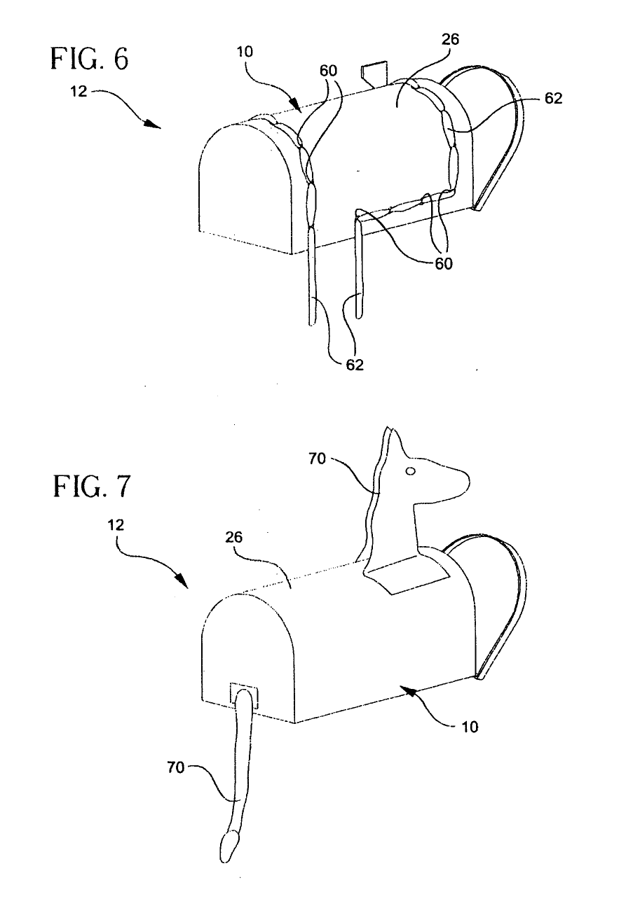

Referring now to FIGS. 6 and 7, the decorative cover 10 may include appendages integrally formed therewith or attachable by the user. In FIG. 6, the decorative cover 10 includes a plurality of holes 60 disposed in the sheet 26 through which ribbon 62 can be threaded to add a decorative touch to the mailbox 12. The holes 60 can be disposed in any arrangement on the decorative cover 10, e.g., along the border thereof as is shown or in any other pattern. Any number of ribbons 62 can be threaded through the holes 60 and tied off in bows or knots at any number of places. In FIG. 7, the decorative cover 10 includes appendages 70 attachable to the sheet 26 using hook-and-loop fastener material or the like. The appendages 70 may be in the form of animal heads, cartoon figureheads, tails, arms, legs, wings, and the like.

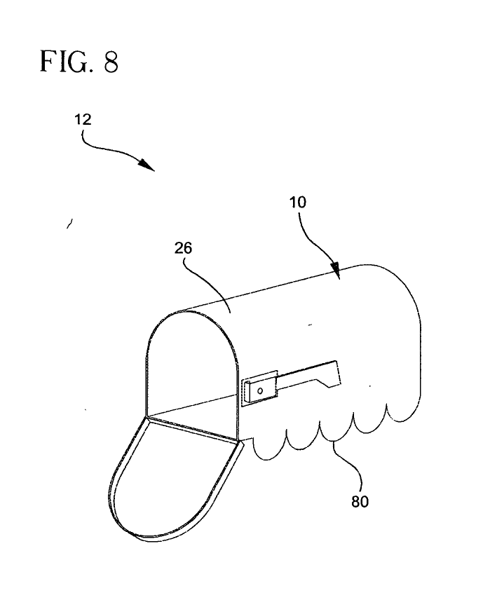

Referring now to FIG. 8, the perimeter of the sheet 26 from which the decorative cover 10 is made may be extended by being cut with a shaped edge 80 or such that areas of the decorative cover 10 are removed. When mounted on the mailbox 12, the sheet 26 may display a fanciful edge (e.g., a design such as a scallop pattern or the like).

In any embodiment (pre-printed designs, user-defined designs, photographs, or adhesive stickers), any combination of design and text may be utilized to provide a personal expression of the mailbox owner.

Referring now to all the Figures, the decorative cover 10 is preferably available as a kit that can be assembled by the mailbox user. The kit includes the sheet 26, means for attaching the sheet onto an exterior surface of the mailbox 12, (e.g., the hook-and-loop fastener material), and means for providing a user-defined design on the exterior surface of the mailbox. The means for providing a user-defined design may include decorative or functional adhesive elements 40 for attachment to the exterior surface of the sheet 26, stick-on letters, numbers, symbols, cutout elements, pictures, combinations of the foregoing items, and the like, or pockets 50, as is shown in FIG. 5. The means for providing the user-defined design may also include marking instruments 46, and combinations of the foregoing items.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but theft the invention will include all embodiments falling within the scope of the appended claims.

1. A decorative cover for a the top and sides of the mailbox, comprising:
a sheet having a weather resistant exterior surface and an interior surface, said sheet having a cutout portion positioned thereon to allow a flag forming part of said mailbox to pass there through when said sheet is positioned on said mailbox; and means on said interior surface of said sheet and said exterior surface of said mailbox for removably attaching said sheet onto said exterior surface of said mailbox.

2. The decorative cover of claim 1, wherein said means for removably attaching said sheet to said mailbox includes hook-and-loop fasteners, a portion of which is adhesively coupled to said mailbox and another portion of which is adhesively coupled to said sheet.

3. The decorative cover of claim 1, wherein said sheet includes a pre-printed design in the form of a pictorial or graphical representation on an outer surface thereof.

4. The decorative cover of claim 1, wherein said sheet is configured to receive a user defined design on an outer surface thereof.

5. The decorative cover of claim 1, wherein said sheet is fabricated of a material selected from the group of materials consisting of thermoplastics, rubbers, papers, metal foils, and combinations of the foregoing materials.

6. A kit for removably attaching a cover to a mailbox, said kit comprising:
a sheet having a weather-resistant exterior surface and an interior surface, said sheet defining a cutout portion positioned thereon to allow a flag forming part of said mailbox to pass there through when said sheet is positioned on said mailbox; means for removably attaching said interior surface of said sheet onto an exterior surface of said mailbox; and means for providing a user-defined design on said exterior surface of said sheet.

7. The kit of claim 6, wherein said means for providing a user-defined design comprises an adhesive element for attachment of said sheet to said exterior surface of said sheet.

8. The kit of claim 7, wherein said adhesive element comprises a stick-on letter, number, symbol, picture, or a combination of the foregoing elements.

9. The kit of claim 6, wherein said means for providing a user-defined design comprises a pocket having a transparent window coupled to a backing member, said transparent window being coupled to said backing member so as to allow for the insertion of a photograph or printed graphic thereon and the retaining of the photograph or printed graphic between said transparent window and said backing member, and said backing member being mountable on said exterior surface of said mailbox or on said sheet.

10. The kit of claim 6, wherein said means for providing a user-defined design comprises a marking instrument selected from the group consisting of a pen, a pencil, and a marker.

11. The kit of claim 6, wherein said means for providing said user-defined design comprises an appendage attachable to said sheet using a hook-and-loop fastener material.

12. The kit of claim 6, wherein said means for providing said user-defined design comprises the threading of ribbon through a hole disposed in said sheet.

13. The kit of claim 6, wherein said means of removably attaching said sheet to said mailbox is hook-and-loop fasteners, a portion of which is adhesively coupled to said mailbox: and another portion of which is adhesively coupled to said sheet.

14. A method of installing a mailbox cover on the top and sides of a mailbox, said method comprising:
attaching one of a hook portion and a loop portion of a hook-and-loop material to an outer surface of a mailbox; attaching the other of said loop portion and said hook portion of said hook-and-loop material to an inner surface of a sheet; and engaging said hook material with said loop material such that said sheet is removably secured to said outer surface of said mailbox.

15. The method of claim 14, further comprising receiving a flag located on said outer surface of said mailbox through a hole in said sheet.

16. The method of claim 14, further comprising decorating said sheet.

17. A method of decorating a mailbox as claimed in claim 14, said method comprising: applying a user-defined design to a sheet attached to an outer surface of said mailbox.
